(19) United States
(12) Patent Application Publication
(10) Pub. No.: US 2023/0050420 A1
(43) Pub. Date: Feb. 16, 2023

(54) Modular Liquid Vending System

(71) Applicant: Maslow Capital Management LLC, Stonington, CT (US)

(72) Inventor: Joseph G. NIGRO, Stonington, CT (US)

(21) Appl. No.: 17/883,921

(22) Filed: Aug. 9, 2022

Related U.S. Application Data
(60) Provisional application No. 63/233,281, filed on Aug. 15, 2021.

(51) Int. Cl. G07F 13/06; B67D 1/12; G07F 9/10

(52) U.S. Cl. CPC G07F 13/065; B67D 1/1202; G07F 9/10; B67D 2210/00136

(57) ABSTRACT

A modular liquid vending system positionable at a selected location for a selected period of time, and method of using same, including a housing having a floor, opposing side walls and opposing end walls. At least one fill terminal is positioned within the housing and has an outlet accessible by a customer to provide a selected quantity of the liquid. At least one storage tank suitable for storing the liquid is positioned within the housing and is connected to the fill terminal. The vending system is transportable by a vehicle to the selected location for the selected period of time.

### CROSS-REFERENCE TO RELATED APPLICATION

This application claims the benefit of U.S. Provisional Patent Application No. 63/233,281 filed on 15 Aug. 2021. The entire contents of the above-mentioned application are incorporated herein by reference as if set forth herein in entirety.

### FIELD OF THE INVENTION

This invention relates to vending machines and dispensers for water and other liquids.

### BACKGROUND OF THE INVENTION

Transport and dispensing of liquids such as water can be challenging due to the weight of the liquid. Many locally-owned spring water sources lack infrastructure to distribute the water.

Access to desirable drinking water can be a daily struggle for millions of people. Types of water currently sold include overlapping categories of spring water, mineral water, purified water, sparkling water and distilled water. Typically, water is sold in containers of various sizes, or is dispensed into containers brought by individual customers.

In some locations, small fixed structures have been built to serve as kiosks for external water sources such as filtered municipal water or local spring water. Such water typically is delivered via conduit from the external water source or via holding tanks that are periodically replenished.

A water dispensing system is disclosed in U.S. Pat. No. 6,138,869 by DiSanto having a plurality of water filling stations. A water supply and filtration system within a cabinet apparently connects to an external source of purified municipal water.

There is also a need for beverages such as water at special events or disaster sites for emergency dispensing after a natural disaster such as a tornado, hurricane or earthquake. Consumption of certain beverages, such as lemonade or iced coffee, is often seasonal.

It is therefore desirable to have a modular system with bulk liquid storage that is portable by truck, rail and/or ship to be deployed where needed and for a selected period of time.

### SUMMARY OF THE INVENTION

An object of the present invention is to provide a modular system for bulk storage and vending of liquids such as water or other beverages at a selected location.

Another object of the present invention is to enable transport and deployment of such modular systems utilizing existing vehicles and equipment.

A still further object of the present invention is to efficiently mobilize bulk liquids and to monetize the liquids at selected locations.

This invention features a modular liquid vending system, also referred to herein as a vending module, positionable at a selected location for a selected period of time, including a housing having a floor, opposing side walls and opposing end walls. At least one fill terminal is positioned within the housing and has an outlet accessible by a customer to provide a selected quantity of liquid such as water or other beverage. At least one storage tank suitable for storing the liquid is positioned within the housing and is connected to the fill terminal. The vending system is transportable by a vehicle to the selected location for the selected period of time.

In some embodiments, the housing is an intermodal container adapted to carry the at least one fill terminal and the at least one storage tank. In a number of embodiments, the housing is configured to be handled by intermodal freight transport such as double-stack rail transport. In certain embodiments, the vending system includes a plurality of fill terminals and a plurality of storage tanks. In some embodiments, the fill terminal includes a transaction unit enabling the customer to pay for the selected quantity of the liquid.

This invention also features a method for dispensing a liquid such as water or other beverage by selecting a vending module, transporting the vending module by a vehicle to the selected location, and enabling customers to select a quantity of the liquid.

In certain embodiments, the method further includes filling the at least one storage tank with drinkable water at the selected location. In other embodiments, the at least one storage tank is filled at least half full with drinkable water prior to transporting the vending module to the selected location. In some embodiments, the method further includes repositioning the vending module, with a selected quantity of water in the storage tanks, by intermodal freight transport to a different location for a second selected period of time.

### BRIEF DESCRIPTION OF THE DRAWINGS

In what follows, preferred embodiments of the invention are explained in more detail with reference to the drawings, in which:

FIG. 1 is a schematic perspective view of a modular liquid vending system according to the present invention;

FIG. 2 is a schematic top plan view of the vending system of FIG. 1 with opposing double swing doors in an open position;

FIG. 3 is a schematic cross-sectional view along lines 3-3 of FIG. 2;

FIGS. 4A and 4B are schematic perspective and side views, respectively, of a potable water tank suitable for storing liquids in a vending system according to the present invention; and

FIG. 5 is a schematic perspective view of a smaller vending system according to the present invention.

### DETAILED DESCRIPTION OF THE PRESENTLY PREFERRED EMBODIMENTS

This invention may be accomplished by a modular vending system including a housing having a floor, opposing side walls and opposing end walls. At least one fill terminal is positioned within the housing and has an outlet accessible by a customer to provide a selected quantity of a liquid such as water. At least one storage tank suitable for storing the liquid is positioned within the housing and is connected to the fill terminal. The vending system is transportable by a vehicle to the selected location for the selected period of time.

In preferred constructions, the housing is a repurposed intermodal container adapted to carry one or more one fill terminals and one or more storage tanks. The intermodal container is suitable for intermodal freight transport. In certain constructions, the housing is custom built and configured to be handled by intermodal freight transport.

The term “intermodal container” is utilized herein as a standard industry term referring to standardized shipping containers typically having a length of 20 feet or 40 feet and a width of eight feet. The intermodal container can be handled by intermodal freight transport.

The term “intermodal freight transport” is utilized herein as a standard industry term referring to transportation of intermodal containers among one or more of flat-bed or tractor-trailer trucks, trains such as double-stack rail transport utilizing well cars, and vessels including container ships.

The present invention is particularly suited to provide beverages such as water at special events, fields, parking lots, residences, any public or private location and/or disaster sites for emergency dispensing after a natural disaster such as a tornado, hurricane or earthquake. The modular configuration of the invention enables mobilizing emergency bulk liquid via conventional intermodal freight transport. The contents of the bulk liquid can be tailored for the type of emergency or to address changing consumption needs such as seasonal dispensing of certain beverages, such as lemonade or iced coffee.

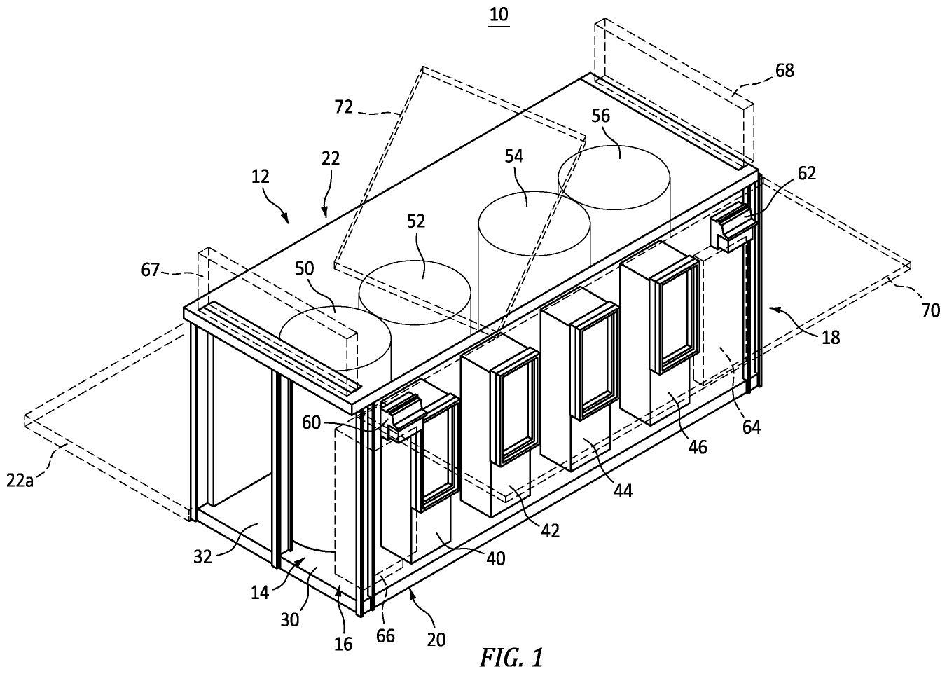

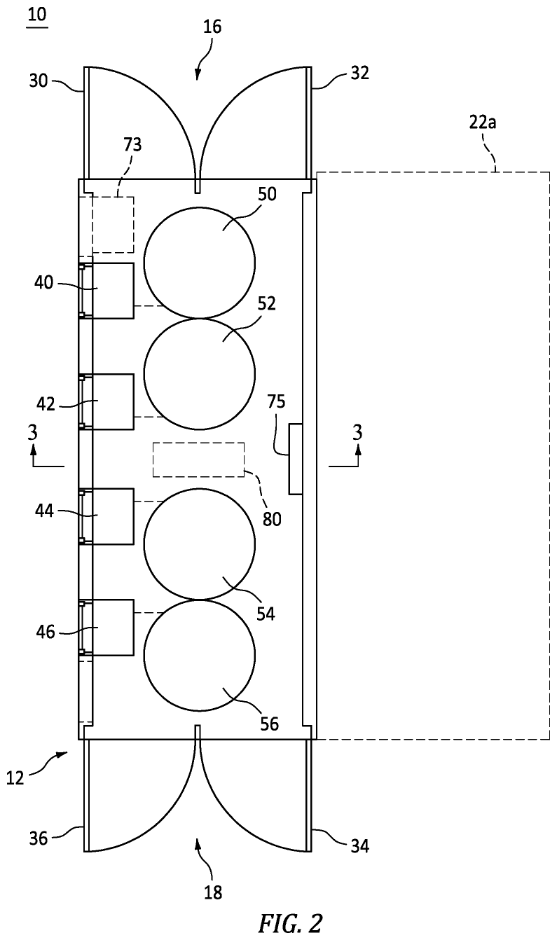

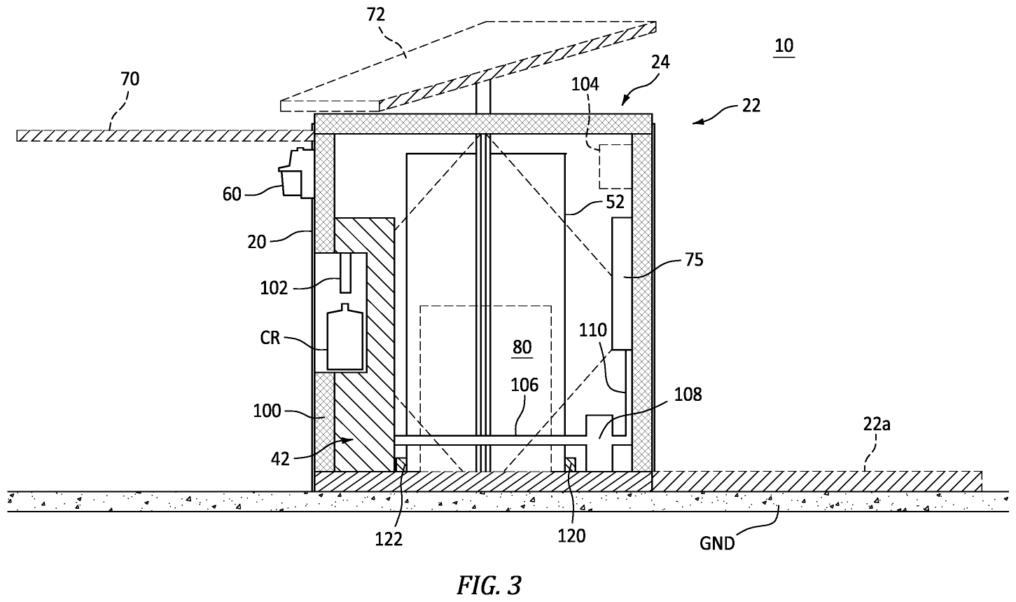

Vending system 10, FIGS. 1-2, has a housing 12 having a floor 14, opposing end walls 16, 18, opposing side walls 20, 22 and a roof 24. One pair of hinged doors 30, 32 form the end wall 16 while another pair of hinged doors 34, 36 form the end wall 18 as is typical of intermodal containers. Roof 24 is a solid material in some constructions, such as corrugated metal and, in other constructions, is a fabric and/or polymeric material. Insulation such as rigid panel insulation 100, FIG. 3, is preferred on the interior surface of all walls and roof 24 where temperatures may drop below the freezing point of liquids carried by vending system 10. Side wall 22 is hinged in one construction so that it can be pivoted downward to a “flip-down” position 22a shown in phantom in FIGS. 1-2.

In this construction, four fill terminals 40, 42, 44 and 46 are positioned against side wall 20 and are supplied directly or indirectly by storage tanks 50, 52, 54 and 56. Fill terminals 40, 42, 46 and 48 each have an outlet accessible by a customer to provide a selected quantity of the liquid carried in the respective storage tanks 50, 52, 54 and 56. Each fill terminal preferably includes a transaction unit enabling the customer to pay for the selected quantity of the liquid by coin, paper currency, credit card, or other interactive payment technique. Customers typically bring their own container to fill, such as 5-gallon container CR shown in FIG. 3, although suitable containers are sold separately in certain constructions. Stackable containers such as polymeric or biodegradable cups or buckets can be readily stored within and/or dispensed by the vending module 10.

In some constructions, each storage tank carries the same liquid as is carried in the other storage tanks; in other constructions, at least one storage tank carries a different liquid than is carried in at least one other storage tank. In some constructions, the storage tanks are interconnected with each other and/or with multiple fill terminals; in other constructions, each storage tank is dedicated to a single fill terminal. Interconnection of the storage tanks carrying the same liquid is preferred to facilitate filling of the tanks with that liquid. In one construction, each storage tank has a capacity of 750 gallons.

Optional exterior LED wall-hung lights 60, 62 are shown in FIG. 1 on opposing end portions of side wall 20 in this construction. Various combinations of internal and external lighting, exterior paint color, exterior faux stone or brick interlocking panels, logos, text and other items can be configured according to vendor preference. Optional interactive digital displays 64, 66 and raised end display panels 67, 68 are shown in phantom in FIG. 1, also to be configured to vendor specifications.

Also shown in phantom in FIG. 1 is a retractable awning 70, powered manually or via a drive motor, to provide shade and/or protection from inclement weather. Precipitation sensors and/or temperature sensors provide signals to a drive control to extend or retract the awing 70 in some constructions while in other constructions remote control is provided. Some constructions have one or more solar panels 72 positioned on roof 24. An optional energy-storage battery 73 is shown in phantom in FIG. 2. Also shown is an energy panel 75, also referred to herein as an electrical panel. Other energy-generating equipment such as wind turbines or fuel-powered generators can be provided to supplement connection to an energy grid or to be utilized off-grid, especially if refrigeration or other temperature control is provided within the housing 12.

An optional grey-water tank 80, having a capacity of 100 gallons, is shown in phantom in FIGS. 2-3 to receive drainage from one or more of the fill terminals due to spillage. As further illustrated in FIG. 3, fill terminal 42 includes recessed fill dispenser 102. An optional heating unit 104 is shown in phantom as a wall-mounted unit in this construction. Also illustrated is piping 106, pump 108 and electrical conduit 110. Piping 106 also represents a section of electrical conduit to power the fill terminal 42 and other devices such as wall light fixture 60. One or more lockable external receptacles can be provided for connecting to local utility power or other external power source. Mechanical and electrical specifications of particular vendors can be met as needed. Also shown is a bumper guide rails 120, 122 with steel plate backing to anchor straps which secure storage tank 52 during transport; similar fixtures can be provided for other storage tanks as needed. Ground GND represents a surface, such as concrete or asphalt, upon which the vending module 10 is placed at a selected location.

In one construction, air circulation within the vending module is provided by a fixed louver with bird and insect screen and at least one extraction fan. Smoke, carbon monoxide and/or heat detection can be provided with sensors connected to external horns, strobe lights, sirens, and/or remote warning messages.

Ozone bottle rinse and/or ultraviolet sterilization can be provided at one or more of the fill terminals. One suitable water dispensing unit is Purely Natural model Series 3 having a stainless-steel cabinet, LED readout, multiple dispensing selections with pause feature, tamper-proof water meter, spring-loaded front door with lighting, coin acceptor with cashless card reader available. One suitable dispensing unit is 30 inches wide, 32 inches hight and 20 inches deep.

One suitable account and card loader kiosk to serve as a transaction unit is ITC Systems model 7880 Loader to handle magnetic stripes, contactless interfaces, and barcoded items as well as currency. Options include card dispenser, receipt printer, high security lock, alarm, and marketing messages.

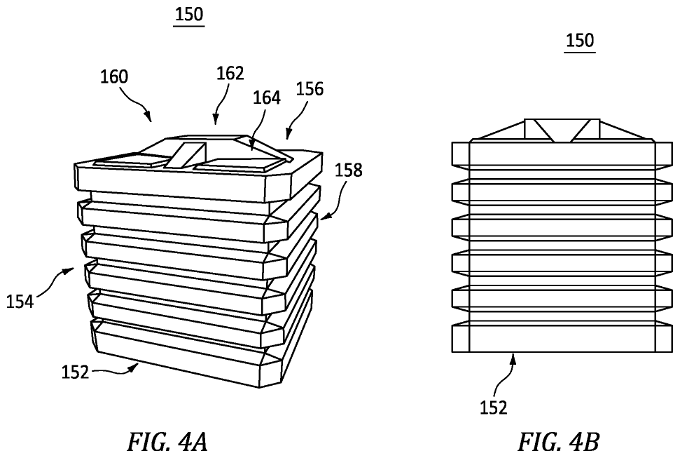

Potable water tank 150, FIGS. 4A-4B, has four sides 152, 154, 156 and 158 plus a top 160 with one or more raised reinforcing ribs 162. At least one fill hatch 164, also referred to as a primary refill port, provides access to the interior of tank 150 to add or remove liquid. One suitable tank, currently available from Zeebest Plastics of Alberta, Canada, is 75 inches wide, 77 inches long, 79 inches high, and has a capacity of 1500 US gallons. A four-sided tank, either generally cubic or rectangular, optimizes storage capacity within a rectangular intermodal housing utilized in a vending system according to the present invention. An external isolation ball valve can be provided for the primary refill port, preferably with lock-off mechanism.

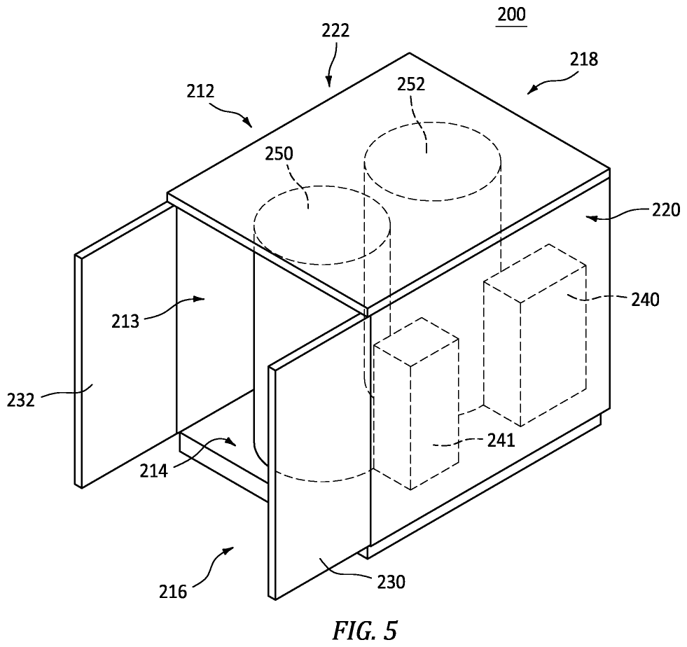

A smaller vending module 200, FIG. 5, has a housing 212 having dimensions in once construction including an external width of eight feet, an external length of ten feet, and a height selected according to an intended usage. Suitable heights typically range between eight feet to ten feet, which includes typical intermodal container heights of eight feet six inches and nine feet six inches. In one construction, vending module 200 is eight feet wide, ten feet long, nine and one/half feet high, and has a dry weight of approximately 5,000 pounds. The housing 212 has a floor 214, opposing end walls 216, 218, opposing side walls 220, 222 and a roof 224 which is a solid material in some constructions, such as corrugated metal and, in other constructions, is a fabric and/or polymeric material. One pair of hinged doors 230, 232 form the end wall 216 in this construction to enable access to the interior space within the housing 212. One or more rubber gaskets can be provided as door seals, also referred to as environmental seals, either mounted on the doors or on the perimeter of the housing 212 that defines the opening 213 into the interior. A drip edge or rain guard can be provided along the upper surface of the opening to direct precipitation away from the opening 213.

In this construction, a single fill terminal 240, also referred to herein as a water dispenser 240, and a cashless kiosk transaction unit 241 are positioned against side wall 220. The water dispenser 240 is supplied directly or indirectly by storage tanks 250 and 252, each of which contains up to 750 gallons of drinkable water in this construction. Water dispenser 240 has an outlet accessible by a customer to provide a selected quantity of the water carried in the respective storage tanks 250 and 252. One or more of the additional features described above in relation to FIGS. 1-3 can be added as desired to the vending module 200.

Vending systems according to the present invention are transportable by a vehicle to the selected location for the selected period of time. Each vending system, also referred to as a vending module, can then be relocated as desired with storage tanks filled with a selected quantity of liquid. To maximize mobilization of the liquid, all storage tanks in a vending module typically will be filled prior to transport.

A vending system according to the present invention typically utilizes a tanker truck to plug into a local spring bulk water supply and then transfer that bulk natural spring water over to one of the inventive vending modules via plugging an industrial hook-up fitting to the back of the vending module. Alternatively, a vending module can be connected directly to existing municipal water lines if desired, or to an atmospheric moisture extractor which harvests water vapor. With this modular vending concept, an unlimited number of vending modules can be delivered to communities all over and connect anyone with supplies from local spring owners, other business owners and/or government officials to maintain them with their natural spring/mineral water supply, as well as to supplement or temporarily replace municipal water sources that become temporarily contaminated with E. coli or other organism or chemical contaminant. Liquids dispensed from the vending modules can be utilized to wash lettuce and other vegetables, and for other desired purposes such as brushing teeth and other personal hygiene needs.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art after reviewing the present disclosure and are within the following claims.

What is claimed is:

1. A modular liquid vending system positionable at a selected location for a selected period of time, comprising:
a housing including a floor, opposing side walls and opposing end walls;
at least one fill terminal positioned within the housing and having an outlet accessible by a customer to provide a selected quantity of liquid;
at least one storage tank suitable for storing the liquid, positioned within the housing and connected to the fill terminal; and
wherein the vending system is transportable by a vehicle to the selected location for the selected period of time.

2. The modular system of claim 1 wherein the housing is an intermodal container adapted to carry the at least one fill terminal and the at least one storage tank.

3. The modular system of claim 1 wherein the housing is configured to be handled by intermodal freight transport.

4. The modular system of claim 1 having a plurality of fill terminals and a plurality of storage tanks.

5. The modular system of claim 1 wherein the fill terminal includes a transaction unit enabling the customer to pay for the selected quantity of the liquid.

6. The modular system of claim 1 wherein the liquid is a beverage.

7. The modular system of claim 1 wherein the liquid is drinkable water.

8. The modular system of claim 1 further including an ice dispenser.

9. A method for dispensing a liquid at a selected location for a selected period of time, comprising:
selecting a vending module having: (a) a housing including a floor, opposing side walls and opposing end walls; (b) at least one fill terminal positioned within the housing and having an outlet accessible by a customer; and (c) at least one storage tank suitable for storing the liquid, positioned within the housing and connected to the fill terminal;
transporting the vending module by a vehicle to the selected location; and
enabling customers to select a quantity of the liquid.

10. The method of claim 9 further including filling the at least one storage tank with drinkable water at the selected location.

11. The method of claim 9 further including filling the at least one storage tank at least half full with drinkable water prior to transporting the vending module to the selected location.

12. The method of claim 9 wherein the housing is an intermodal container modified to carry the at least one fill terminal and the at least one storage tank.

13. The method of claim 9 further including repositioning the vending module by intermodal freight transport to a different location for a second selected period of time.

14. The method of claim 13 wherein repositioning includes transporting the vending module with at least one storage tank being at least half full with drinkable water.
